(19) United States
(12) Patent Application Publication
(10) Pub. No.: US 2003/0183667 A1
(43) Pub. Date: Oct. 2, 2003

(54) Organizer attachment for vehicle sun visor

(76) Inventor: Lee Mantis, Charlotte, NC (US)

Correspondence Address: SCHWARTZ LAW FIRM, P.C., 6100 FAIRVIEW ROAD, SUITE 530, Charlotte, NC, 28210, US

(21) Appl. No.: 10/113,057

(22) Filed: Apr. 1, 2002

(51) Int. Cl. B60R 7/05

(52) U.S. Cl. 224/312; 224/901.4

(57) ABSTRACT

An organizer attachment is provided for a vehicle sun visor having inside and outside major visor surfaces. The sun visor is pivotable between a raised position wherein the inside visor surface resides adjacent an interior ceiling of the vehicle, and a lowered position wherein the outside visor surface resides adjacent a front windshield of the vehicle. The organizer attachment includes a first organizer panel having opposing inside and outside major panel surfaces. The inside panel surface is adapted for residing adjacent the outside visor surface. The outside panel surface defines a first object storage area. A second organizer panel is attached along a longitudinal edge of the first organizer panel, and has opposing inside and outside major panel surfaces including respective second and third object storage areas. The second organizer panel is adapted for pivoting movement between a closed position wherein the second object storage area overlies the first object storage area, and an open position for accessing each of the first and second object storage areas. The third object storage area is accessible in both the open and closed positions of the second organizer panel.

### TECHNICAL FIELD AND BACKGROUND OF INVENTION

This application relates to an organizer attachment for a vehicle sun visor. The invention provides multiple object storage areas for organizing and conveniently storing items commonly used or carried in a vehicle. The invention is especially applicable for holding compact discs and cassette tapes. In other applications, the invention may be used for storing note pads, pens, money, vehicle registration, insurance cards, and the like.

Visor attachments for vehicles are well known in the art. These attachments are typically secured to one side of the visor, and include only one or two major surface areas for object storage. For many users, this limited storage area is sufficient. Other users, however, desire substantially greater storage area, and more particularly, storage area especially designed for holding compact discs and cassette tapes. One possible solution to this problem is to increase the number of organizer panels attached to the visor. However, because the visor is generally held by friction in a desired position selected by the vehicle occupant, the added weight of multiple panels would tend to pivot the panel vertically down allowing little or no angle of adjustment.

A further limitation of prior art visor attachments is their inability to be readily detached from the vehicle visor in order to carry the stored CDs, cassettes, or other objects outside of the vehicle. Most commercially available attachments are secured to the vehicle visor using straps with mating hook and loop fasteners, such as VELCRO®. The straps extend around the visor and are releasably secured to each other at their respective free ends. The process of detaching and reattaching the straps when moving the visor attachment into and out of the vehicle is generally time-consuming and inconvenient.

The present invention addresses these and other problems of the prior art by providing a visor organizer attachment which provides maximum storage space with minimal weight and bulk. In one application, the invention includes three storage areas of even dimension on two organizer panels in which an occupant of the vehicle can store compact discs, cassette tapes as well as other accessories. A third organizer panel may be releasably attached to the organizer attachment and most other attachments to provide more area for storing objects such as compact discs. The invention is conveniently detached and reattached to the vehicle visor. Easy access to the vanity mirror is also a key feature.

### SUMMARY OF INVENTION

Therefore, it is an object of the invention to provide an organizer attachment for a vehicle sun visor.

It is another object of the invention to provide an organizer attachment which is especially applicable for holding compact discs and audio cassettes.

It is another object of the invention to provide an organizer attachment which offers increased storage area with relatively little added weight, as compared to the prior art.

It is another object of the invention to provide an organizer attachment which includes multiple storage areas that are readily accessible to the occupant of vehicle.

It is another object of the invention to provide an organizer attachment which does not block use of the vanity mirror attached to the visor.

It is another object of the invention to provide an organizer attachment which can be easily detached from the visor in order to conveniently carry the stored objects outside of the vehicle.

It is another object of the invention to provide an organizer attachment which includes as many as five separate object storage areas of equal dimension.

These and other objects of the present invention are achieved in the preferred embodiments disclosed below by providing an organizer attachment for a vehicle sun visor having inside and outside major visor surfaces. The sun visor is pivotable between a raised position wherein the inside visor surface resides adjacent an interior ceiling of the vehicle, and a lowered position wherein the outside visor surface resides adjacent a front windshield of the vehicle. The organizer attachment includes a first organizer panel having opposing inside and outside major panel surfaces. The inside panel surface is adapted for residing adjacent the outside visor surface. The outside panel surface defines a first object storage area. At least one strap secures the first organizer panel to the vehicle sun visor. A second organizer panel is attached along a longitudinal edge of the first organizer panel, and has opposing inside and outside major panel surfaces including respective second and third object storage areas. The second organizer panel is adapted for pivoting movement between a closed position wherein the second object storage area overlies the first object storage area, and an open position for accessing each of the first and second object storage areas. The third object storage area is accessible in both the open and closed positions of the second organizer panel. Means located in each of the first, second, and third object storage areas are provided for carrying objects for ready access and use by an occupant of the vehicle.

According to another preferred embodiment of the invention, the means for carrying objects includes a plurality of sleeves adapted for receiving and storing respective compact discs.

According to another preferred embodiment of the invention, the means for carrying objects includes a plurality of utility pockets each having an elastic opening adapted for receiving and storing objects.

According to another preferred embodiment of the invention, the at least one strap includes complementary hook and loop fasteners for removably securing the first organizer panel to the vehicle sun visor.

According to another preferred embodiment of the invention, means are provided for releasably holding the second organizer panel in the closed position.

According to another preferred embodiment of the invention, the first object storage area includes a plurality of sleeves adapted for receiving and storing respective compact discs.

According to another preferred embodiment of the invention, the second object storage area includes a plurality of sleeves adapted for receiving and storing respective compact discs.

According to another preferred embodiment of the invention, the third object storage area includes a plurality of pockets each having an elastic opening for receiving and storing objects.

According to another preferred embodiment of the invention, the elastic opening extends along a lateral dimension of the second organizer panel.

According to another preferred embodiment of the invention, the elastic opening extends along a longitudinal dimension of the second organizer panel.

According to another preferred embodiment of the invention, a third organizer panel has opposing inside and outside major panel surfaces. The inside panel surface is adapted for residing adjacent to the inside visor surface of the vehicle sun visor. The outside panel surface defining a fourth object storage area. The fourth object storage area is readily accessible when the vehicle sun visor is in the lowered position.

According to another preferred embodiment of the invention, the third organizer panel is releasably attached to the at least one strap for securing the first organizer panel to the vehicle sun visor.

According to another preferred embodiment of the invention, a fastener wrap is looped around the at least one strap, and includes fastener means for engaging and securing the third organizer panel to the vehicle sun visor.

In another embodiment, the invention is an organizer attachment for a vehicle sun visor having opposing inside and outside major visor surfaces. The sun visor is pivotable between a raised position, wherein the inside visor surface resides adjacent a ceiling of the vehicle, and a lowered position wherein the outside visor surface resides adjacent a front windshield of the vehicle. The organizer attachment includes a first organizer panel having opposing inside and outside major panel surfaces. The inside panel surface is adapted for residing adjacent the outside visor surface, and the outside panel surface defines a first object storage area. At least one strap secures the first organizer panel to the vehicle sun visor. A second organizer panel is attached along a longitudinal edge of the first organizer panel, and has opposing inside and outside major panel surfaces. One of the panel surfaces includes a second object storage area. The second organizer panel is adapted for pivoting movement between a closed position overlying the first object storage area, and an open position for accessing each of the first and second object storage areas. A third organizer panel has opposing inside and outside major panel surfaces. The inside panel surface is adapted for residing adjacent to the inside visor surface of the vehicle sun visor. The outside panel surface defines a third object storage area. The third object storage area is readily accessible when the vehicle sun visor is in the lowered position. Means are located in each of the first, second, and third object storage areas for carrying objects for access and use by an occupant of the vehicle.

According to another preferred embodiment of the invention, the inside panel surface of the third organizer panel defines a fourth object storage area including means for carrying objects for access and use by the vehicle occupant.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 shows a visor organizer attachment according to one preferred embodiment of the invention with the organizer attachment laid flat to illustrate the inside object display surfaces of the first and second organizer panels;

FIG. 2 shows the outside surfaces of the first and second organizer panels;

FIG. 3 is a perspective view of a vehicle sun visor with the organizer attachment of the present invention secured to the visor by releasable straps;

FIG. 4 is a perspective view of the organizer attachment secured to the vehicle visor, and showing the first and second organizer panels in the closed position and the third object storage area available for ready access by an occupant of the vehicle;

FIG. 5 is a perspective view of the organizer attachment secured to the vehicle visor and showing the first and second organizer panels in the open position for accessing the first, second, and third object storage areas;

FIG. 6 is a perspective view of a visor organizer attachment according to an alternative preferred embodiment of the invention, and showing the organizer attachment removed from the vehicle visor;

FIG. 7 is a perspective view of an organizer attachment according to a third embodiment of the invention, and showing the organizer attachment released from the vehicle visor; and

FIG. 8 is a perspective view of an organizer attachment according to a fourth embodiment of the invention with the organizer attachment released from the vehicle visor, shown in phantom.

### DESCRIPTION OF THE PREFERRED EMBODIMENT AND BEST MODE

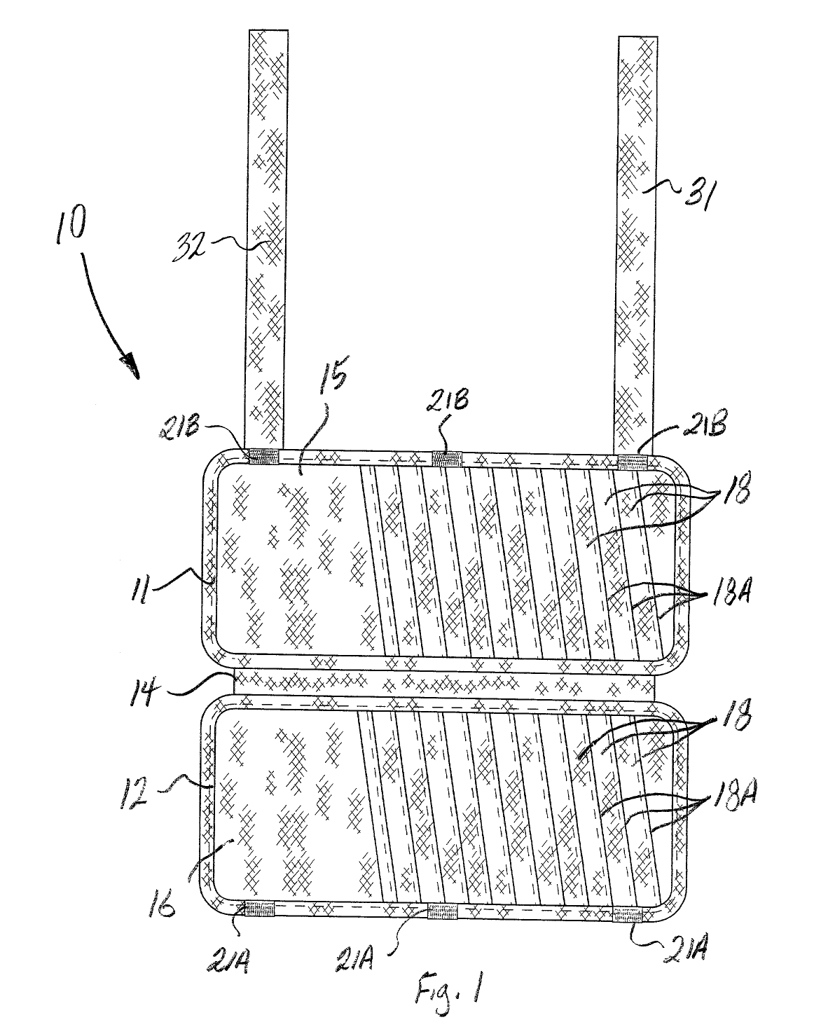

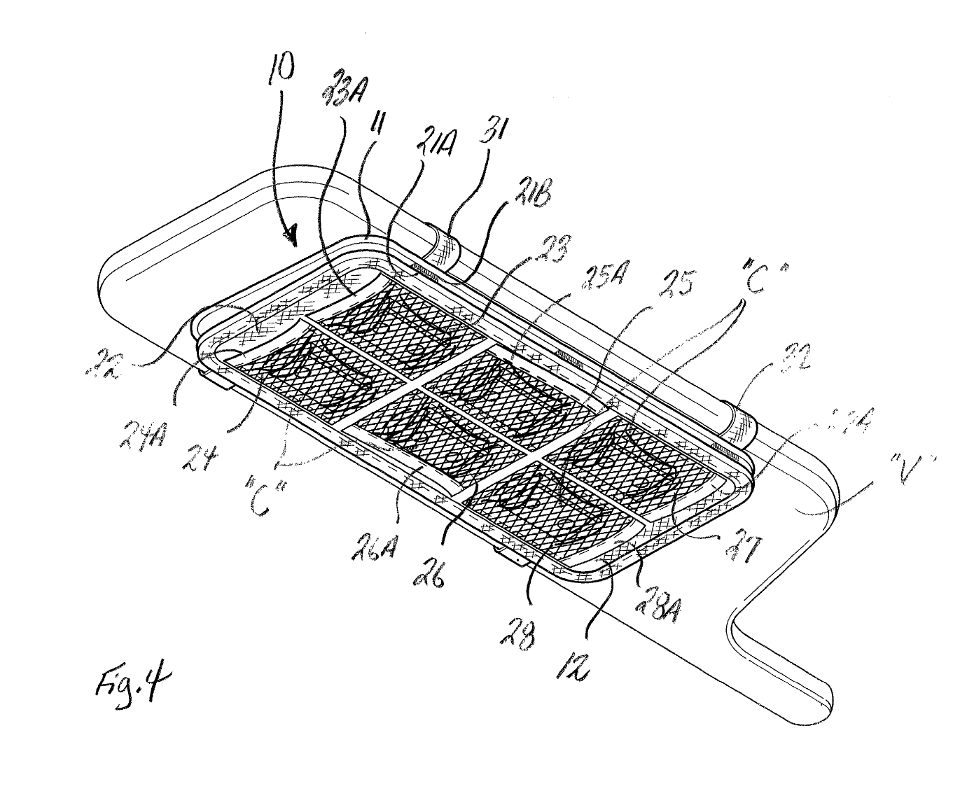

Referring now specifically to the drawings, an organizer attachment for a vehicle sun visor according to the present invention is illustrated in FIG. 1, and shown generally at reference numeral 10. The organizer attachment 10 is especially applicable for holding compact discs “D” and audio cassettes “C”, shown in FIGS. 4, 5, and 6, for convenient and ready access by an occupant of the vehicle. The organizer attachment 10 is usable on either the driver-side or passenger-side visor, and is preferably formed of a durable lightweight fabric such as nylon.

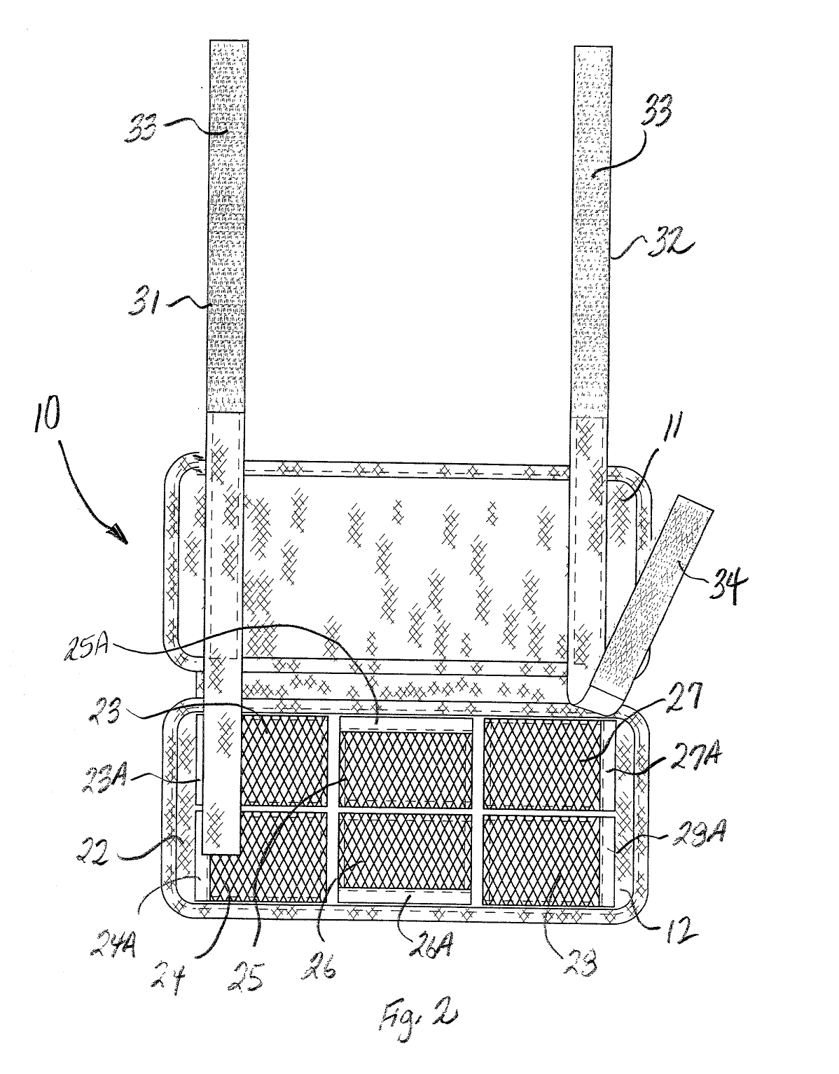

Referring to FIGS. 1 and 2, the organizer attachment 10 includes first and second organizer panels 11 and 12 interconnected along respective longitudinal edges by a flexible hinge strip 14. Each panel 11, 12 has opposing inside and outside major surfaces. The two inside panel surfaces, shown in FIG. 1, define respective object storage areas 15 and 16 including a number of CD sleeves 18 especially designed for receiving and carrying compact discs. The CD sleeves 18 are non-rigid and non-abrasive. According to one embodiment, the organizer panels 11 and 12 can carry as many as 24 compact discs. To facilitate entry and removal of the compact discs, the sleeve openings 18A are preferably angled as shown. Small complementary patches 21A and 21B of hook and loop fasteners, such as VELCRO®, are spaced-apart along marginal inside edges of the first and second panels 11, 12 to releasably fasten the first and second panels 11, 12 together in a closed position (See FIG. 4).

As shown in FIG. 2, the outside surface of the second organizer panel 12 defines a third object storage area 22 including mesh fabric pockets 23, 24, 25, 26, 27, and 28 adapted for receiving and holding audio cassettes. An elastic hem 23A, 24A, 25A, 26A, 27A, and 28A is formed at the opening of each pocket 23-28 to retain the cassettes in the pockets 23-28. Preferably, the elastic hems 23A, 24A, 27A, and 28A of the end pockets 23, 24, 27, and 28 are arranged laterally to permit easier access to the pockets from opposite ends of the panel 12. The elastic hems 25A and 26A of the middle pockets 25 and 26 extend along a length of the panel 12. In an alternative embodiment (not shown), the third object storage area 22 includes additional CD sleeves for receiving and storing respective compact discs.

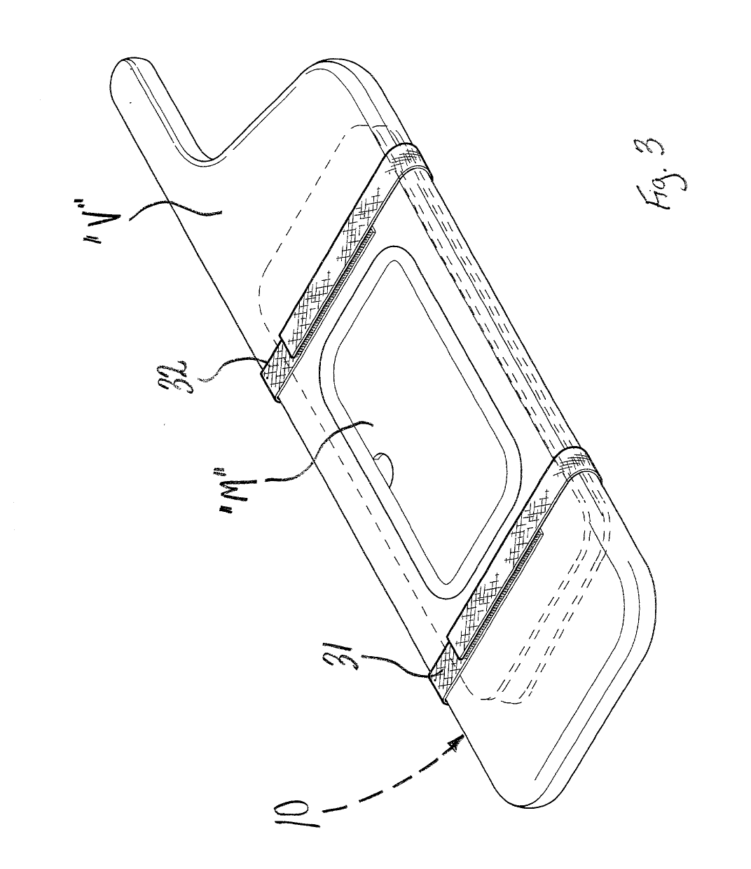

A pair of flexible nylon straps 31 and 32 are sewn to the outside surface of the first organizer panel 11. The straps 31 and 32 are adapted for extending around the vehicle visor “V”, as shown in FIG. 3, to position the organizer attachment 10 adjacent an outside surface of the visor. Preferably, the straps 31 and 32 are sufficiently spaced-apart to avoid interfering with use of the vanity mirror “M” located on an inside surface of the visor “V”. Complementary hook and loop fasteners 33 and 34, such as VELCRO®, are formed with free ends of the straps 31, 32, and cooperate when mated to releasably secure the organizer attachment 10 to the visor “V”. The organizer attachment 10 remains in place upon pivoting movement of the visor “V” between a raised, or stowed, position adjacent the ceiling of the vehicle and a lowered, or in-use, position adjacent the front windshield of the vehicle.

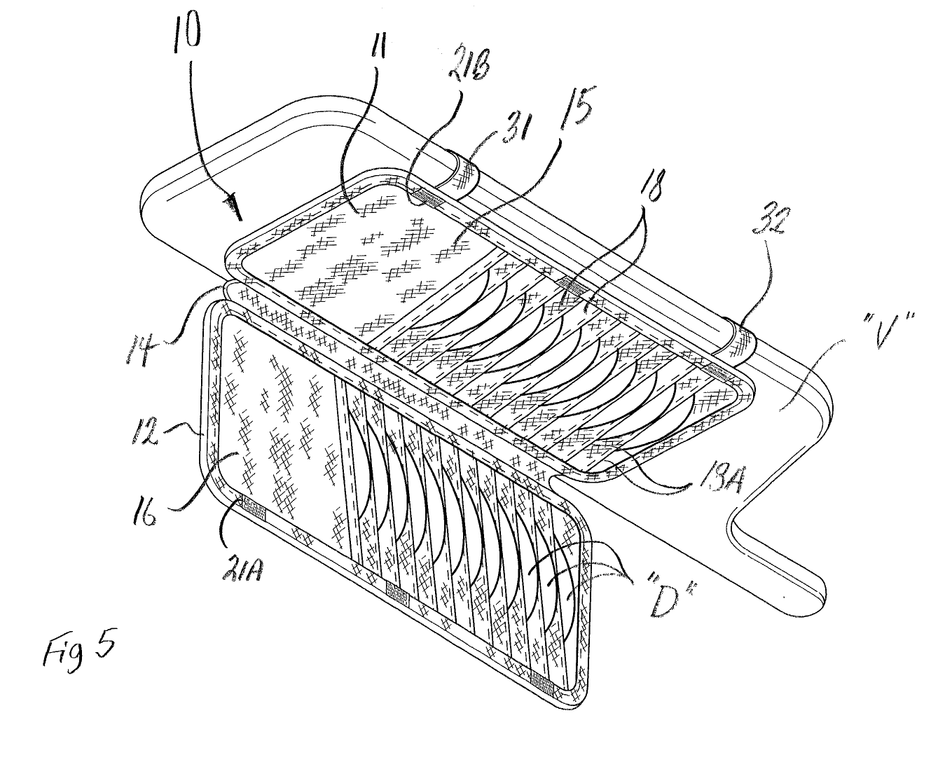

Referring to FIGS. 4 and 5, with the vehicle visor “V” in the raised position and the first and second panels 11, 12 closed, as previously described, the third object storage area 22 is located for convenient access to audio cassettes “C” and other objects stored in the pockets 23-28. Because the pockets 23-28 are formed of a “see-through” mesh fabric, the objects can be readily identified without first being removed from the pockets 23-28. The first and second object storage areas 15 and 16 are accessed by releasing the patches 21A and 21B of hook and loop fasteners, and pivoting the second organizer panel 12 downwardly away from the vehicle occupant to an open position shown in FIG. 5. In the open position, the second organizer panel 12 may also function as an auxiliary sun visor.

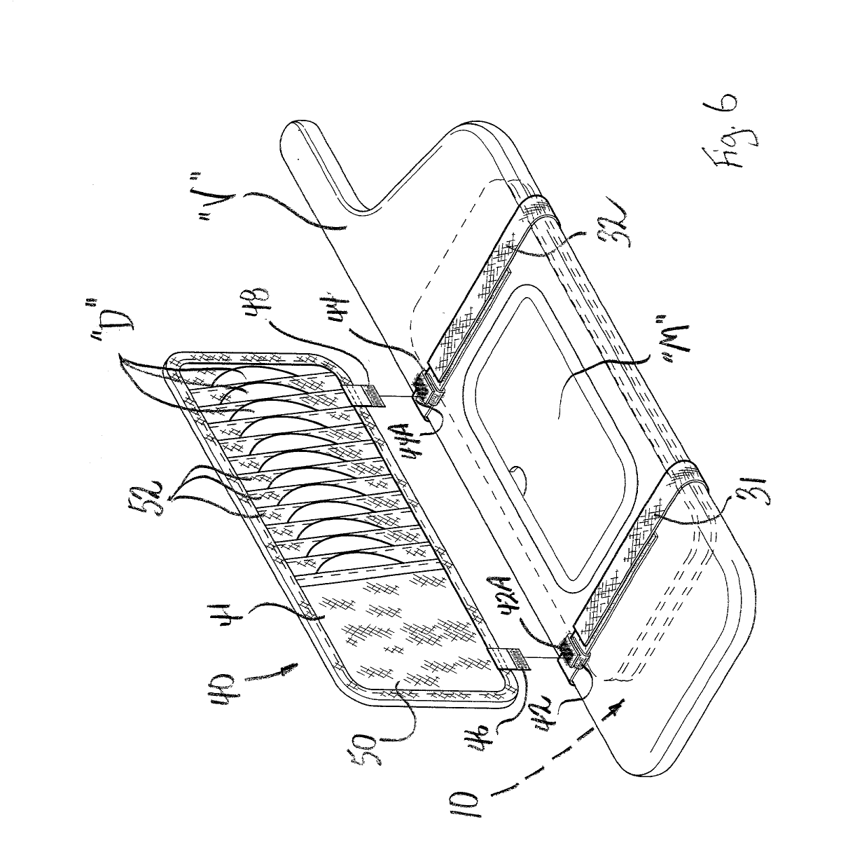

A further embodiment of an organizer attachment 40 according to the present invention is shown in FIG. 6. The organizer attachment 40 comprises a single organizer panel 41 adapted for residing adjacent an inside surface of the vehicle visor “V” and being releasably secured to the straps 31 and 32 of the organizer attachment 10, described above. Removable fastener wraps 42 and 44 with overlying areas of hooks and loops extend around the straps 31, 32, and have respective outside areas 42A and 44A of loops intended to mate with complementary hooks located on tabs 46 and 48 extending from a back edge of the attachment 40. The inside surface of the panel 41 defines an object storage area 50 including CD sleeves 52 especially designed for receiving and carrying compact discs “D”. The opposite panel surface may provide an additional object storage area with CD sleeves and/or pockets (not shown). The organizer attachment 40 can be easily lifted in order to use the vanity mirror “M”, and is conveniently separated from the visor “V” to carry the stored objects outside the vehicle. While the organizer attachment 40 is described for use in combination with the attachment 10, it is equally applicable for use with any other commercially-available attachment which utilizes straps to secure the attachment the vehicle visor “V”.

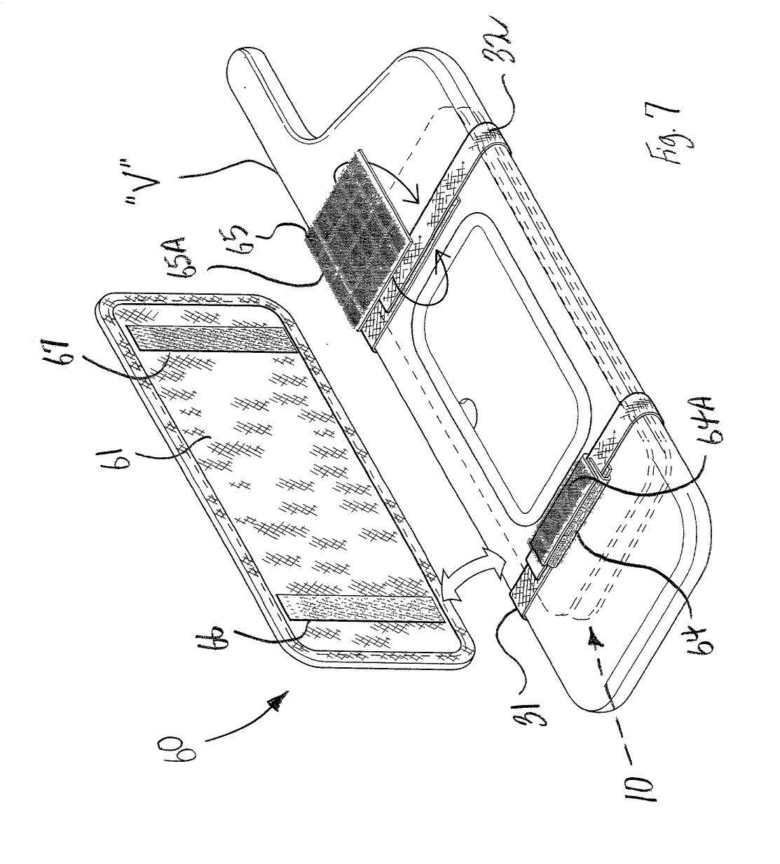

A third embodiment of the invention is illustrated in FIG. 7. The organizer attachment 60 includes a single organizer panel 61 adapted for residing adjacent an inside surface of the vehicle visor “V” and being releasably secured to the straps 31 and 32 of the organizer attachment 10, described above. Removable fastener wraps 64 and 65 with overlying, mating areas of hooks and loops extend around the straps 31, 32 and have respective outside areas 64A and 65A of loops intended to mate with complementary hooks formed in strips 66 and 67 located on an inside major surface of the panel 61. The fastener strips 66, 67 may encompass the entire inside surface of the panel 61. The outside major surface of the panel 61 defines an object storage area (not shown) including CD sleeves, cassette pockets, zipper pockets, pen holders, and the like.

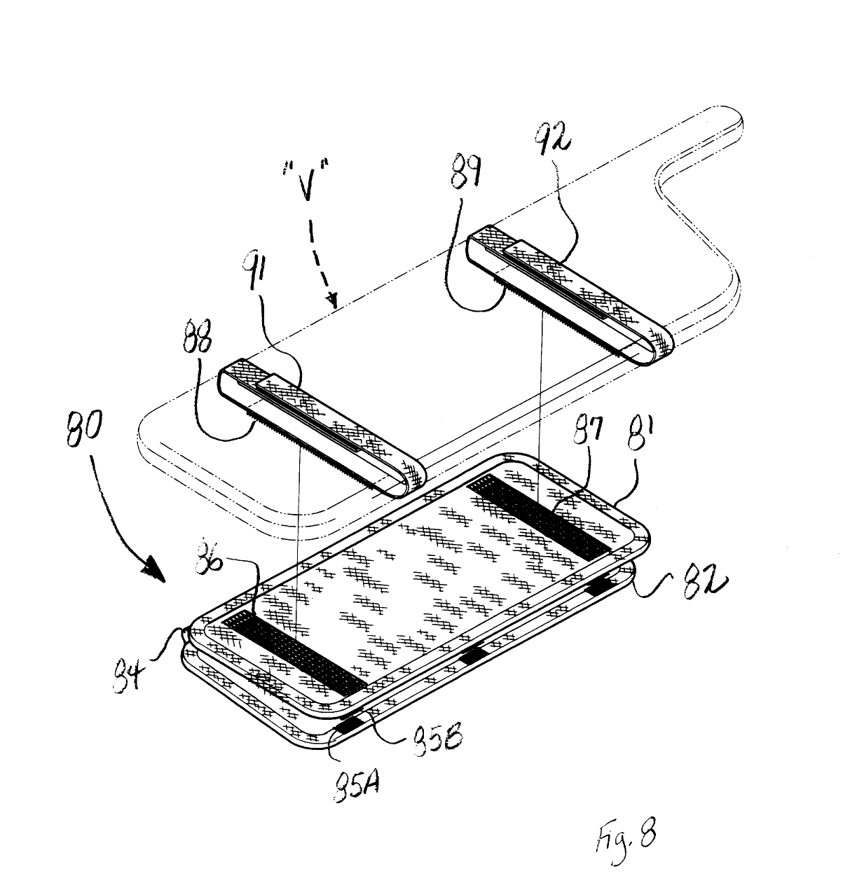

A fourth embodiment of the invention is illustrated in FIG. 8. Like the organizer attachment 10 described above, the organizer attachment 80 includes first and second organizer panels 81 and 82 interconnected along respective longitudinal edges by a flexible hinge strip 84. Each panel 81, 82 has opposing inside and outside major surfaces. The two inside panel surfaces define respective object storage areas (not shown) including CD sleeves, pockets, pen holders, and the like. Small complementary patches 85A and 85B of hook and loop fasteners, such as VELCRO®, are spaced-apart along marginal inside edges of the first and second panels 81, 82 to releasably fasten the first and second panels 81, 82 together in a closed position.

The outside major surface of the organizer panel 81 includes spaced strips 86 and 87 of hook fasteners adapted for mating with complementary loops 88 and 89 formed on respective straps 91 and 92 extending around the vehicle visor “V”. The hooks and loops cooperate to releasably secure the organizer attachment 80 to the visor “V”, such that the attachment 80 can be readily removed from the visor “V” and the stored objects conveniently carried outside of the vehicle.

An organizer attachment for a vehicle sun visor is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. An organizer attachment for a vehicle sun visor having inside and outside major visor surfaces, the sun visor being pivotable between a raised position wherein the inside visor surface resides adjacent an interior ceiling of the vehicle and a lowered position wherein the outside visor surface resides adjacent a front windshield of the vehicle, said organizer attachment comprising:
(a) a first organizer panel having opposing inside and outside major panel surfaces, said inside panel surface adapted for residing adjacent the outside visor surface, and said outside panel surface defining a first object storage area;
(b) at least one strap for securing said first organizer panel to the vehicle sun visor;
(c) a second organizer panel attached along a longitudinal edge of said first organizer panel, and having opposing inside and outside major panel surfaces comprising respective second and third object storage areas, said second organizer panel adapted for pivoting movement between a closed position wherein said second object storage area overlies said first object storage area, and an open position for accessing each of said first and second object storage areas, and said third object storage area being accessible in both the open and closed positions of said second organizer panel; and
(d) means located in each of said first, second, and third object storage areas for carrying objects for ready access and use by an occupant of the vehicle.

2. An organizer attachment according to claim 1, wherein said means for carrying objects comprises a plurality of sleeves adapted for receiving and storing respective compact discs.

3. An organizer attachment according to claim 1, wherein said means for carrying objects comprises a plurality of utility pockets each having an elastic opening adapted for receiving and storing objects.

4. An organizer attachment according to claim 1, wherein said at least one strap comprises complementary hook and loop fasteners for removably securing said first organizer panel to the vehicle sun visor.

5. An organizer attachment according to claim 1, and comprising means for releasably holding said second organizer panel in the closed position.

6. An organizer attachment according to claim 1, wherein said first object storage area comprises a plurality of sleeves adapted for receiving and storing respective compact discs.

7. An organizer attachment according to claim 1, wherein said second object storage area comprises a plurality of sleeves adapted for receiving and storing respective compact discs.

8. An organizer attachment according to claim 1, wherein said third object storage area comprises a plurality of pockets each having an elastic opening for receiving and storing objects.

9. An organizer attachment according to claim 8, wherein said elastic opening extends along a lateral dimension of said second organizer panel.

10. An organizer attachment according to claim 8, wherein said elastic opening extends along a longitudinal dimension of said second organizer panel.

11. An organizer attachment according to claim 1, and comprising a third organizer panel having opposing inside and outside major panel surfaces, said inside panel surface adapted for residing adjacent to the inside visor surface of the vehicle sun visor, and said outside panel surface defining a fourth object storage area, said fourth object storage area being readily accessible when the vehicle sun visor is in the lowered position.

12. An organizer attachment according to claim 11, wherein said third organizer panel is releasably attached to said at least one strap for securing said first organizer panel to the vehicle sun visor.

13. An organizer attachment according to claim 12, and comprising a fastener wrap looped around said at least one strap, and including fastener means for engaging and securing said third organizer panel to the vehicle sun visor.

14. An organizer attachment for a vehicle sun visor having inside and outside major visor surfaces, the sun visor being pivotable between a raised position wherein the inside visor surface resides adjacent an interior ceiling of the vehicle and a lowered position wherein the outside visor surface resides adjacent a front windshield of the vehicle, said organizer attachment comprising:
(a) a first organizer panel having opposing inside and outside major panel surfaces, said inside panel surface adapted for residing adjacent the outside visor surface, and said outside panel surface defining a first object storage area;
(b) at least one strap for securing said first organizer panel to the vehicle sun visor;
(c) a second organizer panel attached along a longitudinal edge of said first organizer panel, and having opposing inside and outside major panel surfaces comprising respective second and third object storage areas, said second organizer panel adapted for pivoting movement between a closed position wherein said second object storage area overlies said first object storage area, and an open position for accessing each of said first and second object storage areas, and said third object storage area being accessible in both the open and closed positions of said second organizer panel;
(d) a third organizer panel having opposing inside and outside major panel surfaces, said inside panel surface adapted for residing adjacent to the inside visor surface of the vehicle sun visor, and said outside panel surface defining a fourth object storage area, said fourth object storage area being readily accessible when the vehicle sun visor is in the lowered position;
(e) a fastener wrap looped around said at least one strap, and including fastener means for engaging and securing said third organizer panel to the vehicle sun visor; and
(f) means located in each of said first, second, third, and fourth object storage areas for carrying objects for access and use by an occupant of the vehicle, said means selected from the group consisting of at least one sleeve for receiving and storing a compact disc, and at least one pocket having an elastic opening for receiving and storing objects.

15. An organizer attachment according to claim 14, wherein said at least one strap comprises complementary hook and loop fasteners for removably securing said first organizer panel to the vehicle sun visor.

16. An organizer attachment according to claim 14, and comprising means for releasably holding said second organizer panel in the closed position.

17. An organizer attachment according to claim 14, wherein said first object storage area comprises a plurality of sleeves adapted for receiving and storing respective compact discs.

18. An organizer attachment according to claim 14, wherein said second object storage area comprises a plurality of sleeves adapted for receiving and storing respective compact discs.

19. An organizer attachment according to claim 14, wherein said third object storage area comprises a plurality of pockets each having an elastic opening for receiving and storing objects.

20. An organizer attachment according to claim 19, wherein said elastic opening extends along a lateral dimension of said second organizer panel.

21. An organizer attachment according to claim 19, wherein said elastic opening extends along a longitudinal dimension of said second organizer panel.

22. An organizer attachment for a vehicle sun visor having inside and outside major visor surfaces, the sun visor being pivotable between a raised position wherein the inside visor surface resides adjacent an interior ceiling of the vehicle and a lowered position wherein the outside visor surface resides adjacent a front windshield of the vehicle, said organizer attachment comprising:
(a) a first organizer panel having opposing inside and outside major panel surfaces, said inside panel surface adapted for residing adjacent the outside visor surface, and said outside panel surface defining a first object storage area;
(b) at least one strap for securing said first organizer panel to the vehicle sun visor;
(c) a second organizer panel attached along a longitudinal edge of said first organizer panel, and having opposing inside and outside major panel surfaces one of which comprises a second object storage area, said second organizer panel adapted for pivoting movement between a closed position overlying said first object storage area, and an open position for accessing each of said first and second object storage areas;
(d) a third organizer panel having opposing inside and outside major panel surfaces, said inside panel surface adapted for residing adjacent to the inside visor surface of the vehicle sun visor, and said outside panel surface defining a third object storage area, said third object storage area being readily accessible when the vehicle sun visor is in the lowered position; and
(e) means located in each of said first, second, and third object storage areas for carrying objects for access and use by an occupant of the vehicle.

23. An organizer attachment according to claim 22, wherein the inside panel surface of said third organizer panel defines a fourth object storage area including means for vehicle occupant.

24. An organizer attachment according to claim 22, wherein the inside surface of said first organizer panel includes reasonable fasteners adapted for mating with complemantary fasteners located on the outside surface of the vehicle visor to releasably secure said organizer attachment to the visor.
